(19) United States
(12) Patent Application Publication
(10) Pub. No.: US 2011/0134352 A1
(43) Pub. Date: Jun. 9, 2011

(54) LIQUID CRYSTAL DISPLAY PANEL

(75) Inventor: Hidetoshi Nakagawa, Osaka (JP)

(73) Assignee: SHARP KABUSHIKI KAISHA, Osaka (JP)

(21) Appl. No.: 13/055,924

(22) PCT Filed: Aug. 11, 2009
(86) PCT No.: PCT/JP2009/003856

§ 371 Date: Jan. 25, 2011

(30) Foreign Application Priority Data
Aug. 19, 2008 (JP) 2008-210870

(51) Int. Cl. G02F 1/1339; G02F 1/1368

(52) U.S. Cl. 349/43

(57) ABSTRACT

A liquid crystal display panel of the present invention includes a liquid crystal layer 42 interposed between a first substrate 10 and a second substrate 20, and a sealant portion 32, which surrounds the liquid crystal layer, the sealant portion being made of a sealant containing a photocurable resin 34a and conductive beads 34b. The first substrate includes a wiring 51, which intersects, in a non-display region, with two mutually adjoining sides of the second substrate. The wiring has two conductive layers 52 and 54, which are layered with an insulating layer 53 sandwiched therebetween. Two contact sections 58 that are formed where the wiring intersects with the sealant portion include contact holes 17a formed in an organic insulating film 17 and an insulating layer 53, and a contact layer 58 that is in contact with the conductive layer in the contact holes. A black matrix 22 and an opposite electrode 24 overlap the sealant portion 32, and the opposite electrode 24 is not formed in a region of the second substrate 20 that face the contact section.

### TECHNICAL FIELD

The present invention relates to a liquid crystal display panel. More particularly, the present invention relates to a liquid crystal display panel having thin film transistors (hereinafter “TFTs”).

### BACKGROUND ART

Liquid crystal display devices have been widely in use in recent years as an alternative to the CRT, and liquid crystal display panels having TFTs (TFT type liquid crystal display panels) are the mainstream liquid crystal display devices today. A TFT type liquid crystal display panel includes a TFT for each pixel, and gate signals (scanning signals) and source signals (display signals) are supplied from a gate driver and a source driver to the TFT, respectively.

The gate driver and the source driver are mounted on the liquid crystal display panel in the form of IC chips, in TCPs (tape carrier packages) or as COFs (chips on film). The gate driver and source driver are connected to a signal processor IC mounted on an FPC (flexible printed circuit board). Predetermined signals and a drive power supply voltage are supplied to each of the drivers through wirings formed on the FPC or COF (or TCP) and wirings formed on the TFT substrate of the liquid crystal display panel. In order to make the peripheral portion of the display of the liquid crystal display device (hereinafter “frame”) narrower, TCPs are being replaced by COFs, and furthermore, COGs (chips on glass), in which IC chips are mounted directly on the frame region (non-display region) of the TFT substrate of the liquid crystal display panel, have also been put into practical use.

For example, Patent Documents 1 and 2 disclose structures, in which signals and power supply voltage are supplied to the gate driver mounted in the frame region of the TFT substrate of the liquid crystal display panel from FPCs disposed on the source driver side through the gate driver wiring formed on the frame region of the TFT substrate.

### RELATED ART DOCUMENTS

### Patent Documents

Patent Document 1: Japanese Patent Application Laid-Open Publication No. 2005-215530

Patent Document 2: Japanese Patent Application Laid-Open Publication No. 2008-32920

### SUMMARY OF THE INVENTION

### Problems to be Solved by the Invention

In the liquid crystal display devices described in the above-mentioned Patent Documents 1 and 2, however, the gate driver wiring, which is disposed in the frame region of the TFT substrate of the liquid crystal display panel, is arranged in such a manner as not to overlap the opposite substrate, (e.g., see FIG. 13 in Patent Document 2). This arrangement sets a limitation on the extent that the frame region of the liquid crystal display panel can be made narrower.

The reason that the gate driver wiring is disposed in such a manner as not to overlap the opposite substrate according to Patent Documents 1 and 2 is that, in that way, the sealant can be cured by irradiating with the light from the side of the opposite substrate.

A sealant portion, by which the TFT substrate and the opposite substrate are bonded together, seals a liquid crystal layer between the substrates, and is formed of a sealant containing photocurable resin and conductive beads. The conductive beads are mixed into the sealant for forming a “Common” transfer contact (common voltage transfer section).

In order to irradiate the sealant with a curing light from the side of the opposite substrate, it is necessary to make sure that at least the black matrix formed on the opposite substrate does not overlap the sealant portion. The black matrix is employed for preventing stray light from entering the display portion of the liquid crystal display panel and has at least a predetermined width (W1 in FIG. 2) around the display region.

On the other hand, if a structure in which the sealant portion overlaps the gate driver wiring is employed, an adequate amount of light (typically ultraviolet ray) for curing the sealant cannot be irradiated from the side of the TFT substrate.

As described above, in order to irradiate the sealant with the curing light from the side of the opposite substrate, at least the black matrix formed on the opposite substrate needs to be disposed in such a manner as not to overlap the sealant portion. This arrangement sets a limitation on the extent that the frame region of the liquid crystal display panel can be made narrower.

The present invention was devised in consideration of the points discussed above, and is aiming mainly at providing a liquid crystal display panel having a narrower frame region than in the conventional art.

### Means for Solving the Problems

A liquid crystal display panel according to the present invention includes a first substrate having a first transparent substrate, a plurality of pixel electrodes formed thereon, a plurality of TFTs formed thereon, a plurality of gate bus lines formed thereon, a plurality of source bus lines formed thereon, and an organic insulating film covering the aforementioned plurality of gate bus lines and the aforementioned plurality of source bus lines; a second substrate having a second transparent substrate, a black matrix formed thereon and an opposite electrode disposed thereon; a liquid crystal layer interposed between the aforementioned first substrate and the aforementioned second substrate; a sealant portion surrounding the aforementioned liquid crystal layer, the aforementioned sealant portion being made of a sealant containing a photocurable resin and conductive beads. The aforementioned liquid crystal display panel has a display region and a non-display region surrounding the aforementioned display region; the aforementioned first substrate includes a wiring that crosses a first side and a second side of the aforementioned second substrate, the aforementioned first and second sides adjoining each other; the aforementioned wiring includes two conductive layers which are layered with an insulating layer sandwiched therebetween; the aforementioned first substrate includes a first contact section formed where the aforementioned wiring crosses a first sealant segment of the aforementioned sealant portion that is in parallel with the aforementioned first side and a second contact section formed where the aforementioned wiring crosses a second sealant segment of the aforementioned sealant portion that is in parallel with the aforementioned second side; the aforementioned first contact section and the aforementioned second contact section each have a contact hole formed in the aforementioned organic insulating film and in the aforementioned insulating layer and a contact layer that is in contact with the aforementioned two conductive layers inside the aforementioned contact hole; the aforementioned black matrix and the aforementioned opposite electrode of the aforementioned second substrate overlap at least a part of the aforementioned sealant portion; and the aforementioned opposite electrode is not formed in regions of the aforementioned second substrate that face the aforementioned first contact section and second contact section.

In an embodiment, the aforementioned respective two conductive layers are formed of the same conductive layer as that of the aforementioned plurality of gate bus lines and the same conductive layer as that of the aforementioned plurality of source bus lines, respectively.

In another embodiment, the aforementioned wiring has openings where the aforementioned wiring overlaps the aforementioned first and second sealant segments.

In another embodiment, the aforementioned contact layer is formed of the same conductive layer as that of the aforementioned plurality of pixel electrodes.

In another embodiment, the aforementioned black matrix overlaps the entirety of the aforementioned sealant portion.

In another embodiment, the aforementioned first substrate has a recess in which the aforementioned organic insulating film is not present at a corner portion of a pattern of the aforementioned sealant portion.

In another embodiment, an end of the aforementioned wiring is connected to a gate driver disposed on the aforementioned first substrate.

### Effects of the Invention

The present invention allows the frame of the liquid crystal display panel to be narrower than in the conventional art. In the liquid crystal display panel of the present invention, since the wiring (the gate driver wiring, for example) formed in the non-display region (frame region) of the TFT substrate has a multilayered structure of two or more layers, the width of the wiring can be made narrower than in the conventional art. As a result, the sealant can be cured by irradiation with the light from the side of the TFT substrate. The black matrix and the opposite electrode on the opposite substrate can overlap at least part of the sealant portion and the aforementioned wiring formed in the non-display region of the TFT substrate.

### BRIEF DESCRIPTION OF THE DRAWINGS

FIG. 1(a) is a schematic plan view of a frame region of a liquid crystal display panel 100A according to an embodiment of the present invention. FIG. 1(b) is a schematic cross-sectional view taken along the line 1B-1B′ of FIG. 1(a).

FIG. 2 is a schematic plan view illustrating the structure of a liquid crystal display module 100 in which the liquid crystal display panel 100A has drivers mounted thereon.

FIG. 3(a) is a schematic plan view of a frame region of a liquid crystal display panel 100B according to another embodiment of the present invention. FIG. 3(b) is a schematic cross-sectional view taken along the line 3B-3B′ of FIG. 3(a).

FIG. 4(a) is a schematic plan view of a frame region of a liquid crystal display panel 100C according to yet another embodiment of the present invention. FIG. 4(b) is a schematic cross-sectional view taken along the line 4B-4B′ of FIG. 4(a).

FIG. 5 is a schematic plan view of a frame region of a liquid crystal display panel 100D according to yet another embodiment of the present invention.

FIG. 6 is a schematic plan view illustrating the structure of a liquid crystal display module 200 in which the liquid crystal display panel 100A has drivers mounted thereon.

### DETAILED DESCRIPTION OF EMBODIMENTS

Structures of liquid crystal display panels and liquid crystal display modules in which the liquid crystal display panel having drivers mounted thereon according to embodiments of the present invention will be described below with reference to the drawings. It should be noted that the present invention is not limited to the embodiments described as examples below.

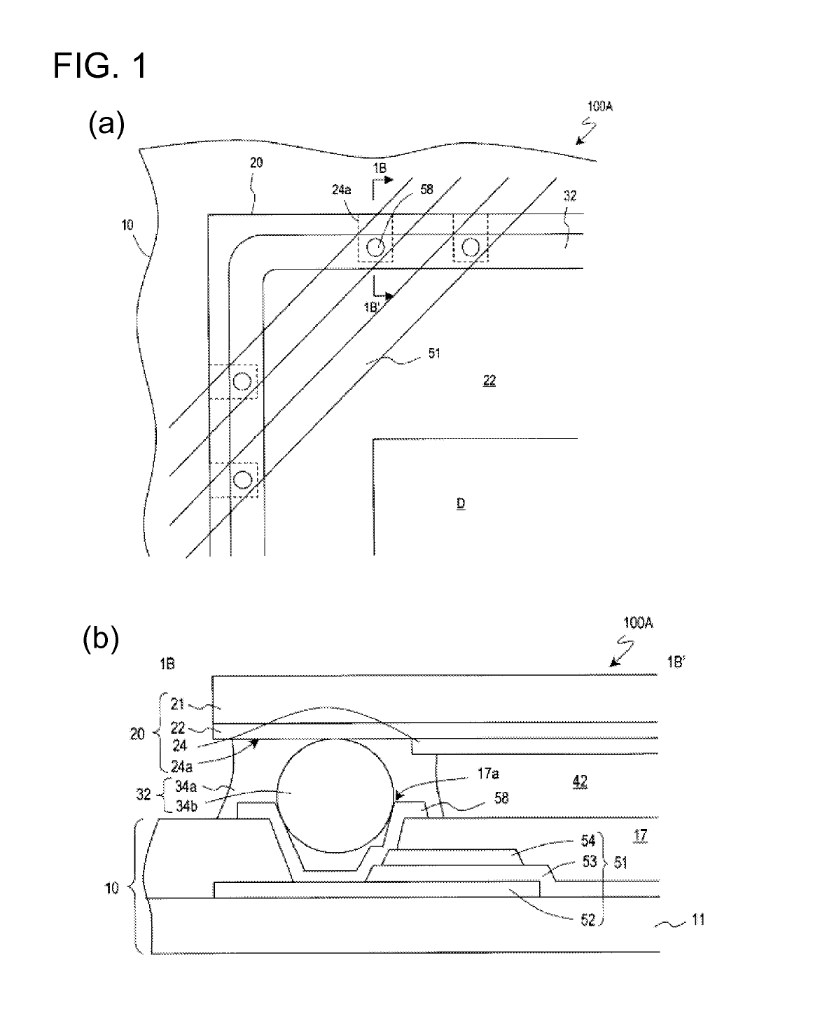

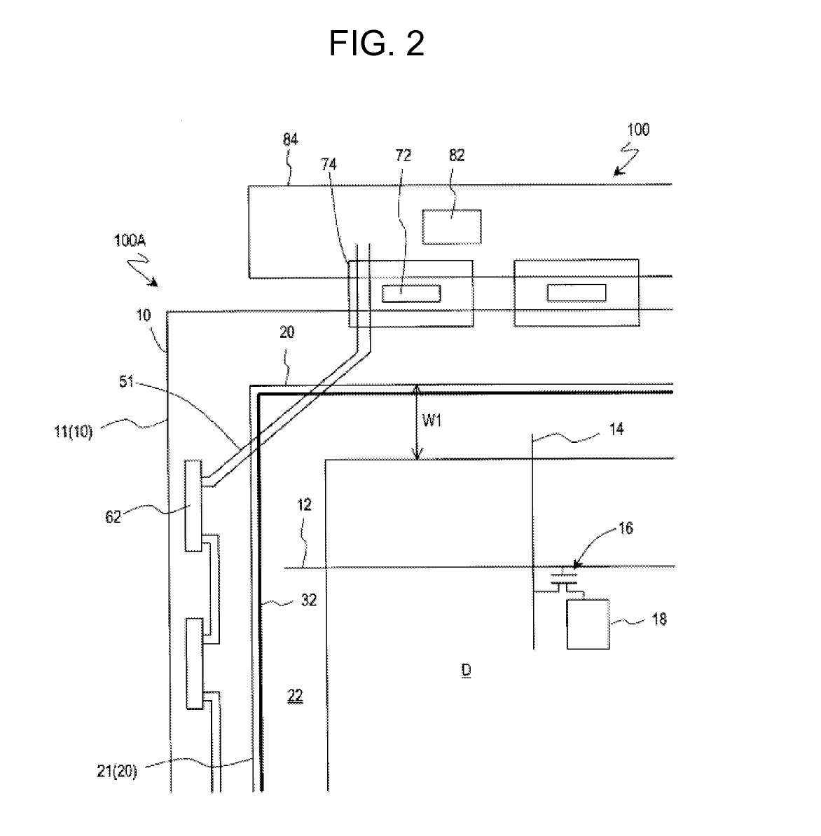

FIG. 1 schematically shows the structure of a frame region of a liquid crystal display panel 100A according to an embodiment of the present invention, and FIG. 2 schematically shows the structure of a liquid crystal display module 100 in which the liquid crystal display panel 100A has drivers mounted thereon.

FIG. 1(a) is a schematic plan view of the frame region of the liquid crystal display panel 100A, and FIG. 1(b) is a schematic cross-sectional view taken along the line 1B-1B′ of FIG. 1(a).

The liquid crystal display panel 100A includes a TFT substrate 10, an opposite substrate 20, and a liquid crystal layer 42 interposed between the TFT substrate 10 and the opposite substrate 20.

The TFT substrate 10 includes a transparent substrate (a glass substrate, for example) 11, a plurality of pixel electrodes 18, a plurality of TFTs 16, a plurality of gate bus lines 12, a plurality of source bus lines 14, and an organic insulating film 17 covering the plurality of gate bus lines 12 and the plurality of source bus lines 14. Furthermore, the TFT substrate 10 includes CS bus lines (auxiliary capacitance bus lines) as needed. The pixel electrode 18 is connected to the source bus line 14 through the TFT 16, and the gate bus line 12 is connected to the gate electrode of the TFT 16. Furthermore, an alignment film (not shown) is formed over the substantially entire surface of the TFT substrate 10 on the side that faces the liquid crystal layer 42. The plurality of pixel electrodes 18 formed on the TFT substrate 10 are arranged in a matrix and constitute a display region D of the liquid crystal display panel 100A. A region surrounding the display region D of the liquid crystal display panel 100A and not contributing to the display region D is called a non-display region or a frame region.

The opposite substrate 20 includes a transparent substrate (a glass substrate, for example) 21, a black matrix (light shielding layer) 22, and an opposite electrode 24. A color filter layer (not shown) is disposed on the opposite substrate 20 as needed. Furthermore, an alignment film (not shown) is disposed over the substantially entire surface of the opposite substrate 20 on the side that faces the liquid crystal layer 42.

The liquid crystal layer 42 interposed between the TFT substrate 10 and the opposite substrate 20 is surrounded by a sealant portion 32. The sealant portion 32 is formed of a sealant containing a photocurable resin 34a and conductive beads 34b. Out of a large number of conductive beads 34b mixed into the sealant, those present between certain terminal sections (common terminal sections, not shown) on the TFT substrate 10 and the opposite electrode 24 function as a “Common” transfer contact.

The TFT substrate 10 has, in the non-display region, a wiring 51, which crosses a first side (a side parallel to the horizontal direction in the figure, a first edge) and a second side (a side parallel to the vertical direction in the figure, a second edge) of the opposite substrate 20, which first and second sides are adjoining each other. The wiring 51 is a wiring for a gate driver 62, for example. The wiring 51 includes two conductive layers 52 and 54, which are layered with an insulating layer 53 sandwiched therebetween (see FIG. 1(b)). The conductive layer 52 is formed of the same conductive layer as that of the gate electrode of the TFT 16, and the conductive layer 54 is formed of the same conductive layer as that of the source electrode (and drain electrode) of the TFT 16, for example. The insulating layer 53 is formed of the same insulating layer as the gate insulating layer, for example.

The TFT substrate 10 includes two contact sections 58 formed where the wiring 51 crosses (overlaps) a segment of the sealant portion 32 that is parallel to the horizontal direction, and where the wiring 51 crosses a segment of the sealant portion 32 that is parallel to the vertical direction. Each of the two contact sections 58 has a contact hole 17a formed in the organic insulating film 17 and the insulating layer 53, and a contact layer 58, which is in contact with the two conductive layers 52 and 54 inside the contact hole 17a (the same reference numeral is used for the contact section and the contact layer). The contact layer 58 is formed of the same conductive layer (ITO film) as that of the pixel electrode 18, for example.

With the contact sections 58 thus formed where the wiring line 51 intersects with two segments of the sealant portion 32 that are respectively parallel to the two mutually adjoining sides (edges) of the opposite substrate 20, the distance between the two contact sections 58 can be made longer than in the case of forming the contact sections inside the sealant portion 32 (closer to the display region D). This configuration can effectively utilize the effect of the low resistance due to the double-layered structure of the wiring 51. Although the wiring 51 has a double-layered structure only between the two contact sections 58, the structure of the wiring 51 is not limited to this.

The black matrix 22 and the opposite electrode 24 on the opposite substrate 20 overlap at least a portion of the sealant portion 32. Here, the black matrix 22 having a width W1 is formed in such a manner as to overlap the entire sealant portion 32 (see FIG. 2). This configuration can minimize the width of the frame region of the opposite substrate 20.

Furthermore, the opposite electrode 24 is formed in such a manner as to overlap the sealant portion 32, so that the conductive beads 34b contained in the sealant portion 32 can form a common transfer. In other words, similar to the black matrix 22, the opposite electrode 24 is formed to extend all the way to the edge of the opposite substrate 20. However, the opposite electrode 24 is not formed in regions on the opposite substrate 20 that are facing the contact section 58. That is, as shown in FIG. 1, notches (or openings) 24a are formed in regions of the opposite electrode 24 that face the contact sections 58.

Since the notches 24a are thus formed in the regions of the opposite electrode 24 that face the contact sections 58, the wiring 51 and the opposite electrode 24 are prevented from being electrically connected to each other, even when the conductive beads 34b, contained in the sealant, come into contact with the contact section 58.

As shown in the liquid crystal display module 100 in FIG. 2, one end of the wiring 51 is connected to the gate driver 62 disposed in the frame region of the TFT substrate 10. The other end (not shown) of the wiring 51 is electrically connected to a COF (or a TCP) 74, which includes a source driver 72, and a FPC 84, which includes a signal processor IC 82. The signals and power supply for the gate driver is supplied from this end of the wiring 51. In the liquid crystal display module 100 in FIG. 2, the gate drivers 62 are mounted on the TFT substrate 10 with the COG method.

As clearly shown in FIG. 2, when the wiring 51 is formed in such a way as to cross two mutually adjoining sides of the opposite substrate 20 in a straight line, the wiring 51 would be shorter compared with cases where the wiring 51 is routed not to overlap the opposite substrate 20. Furthermore, by employing a double-layered structure for the portion of the wiring 51 that overlaps the black matrix 22 on the opposite substrate 20, the resistance of the wiring 51 is lowered, which allows the width of the wiring 51 to be narrower. As a result, when the sealant constituting the sealant portion 32 is irradiated with the light from the side of the TFT substrate 10, the blocking of the light by the wiring 51 is minimized, and therefore the sealant can be adequately cured.

As described above, in the case of liquid crystal display panel 100A, the light (UV ray) for curing the sealant can be irradiated from the side of the TFT substrate 10 in the manufacturing process. The black matrix 22, therefore, can be disposed over the entirety of the sealant portion 32 as shown in FIG. 2.

With the structure described above, the frame region of the liquid crystal display panel 100A can be made narrower than in the conventional art.

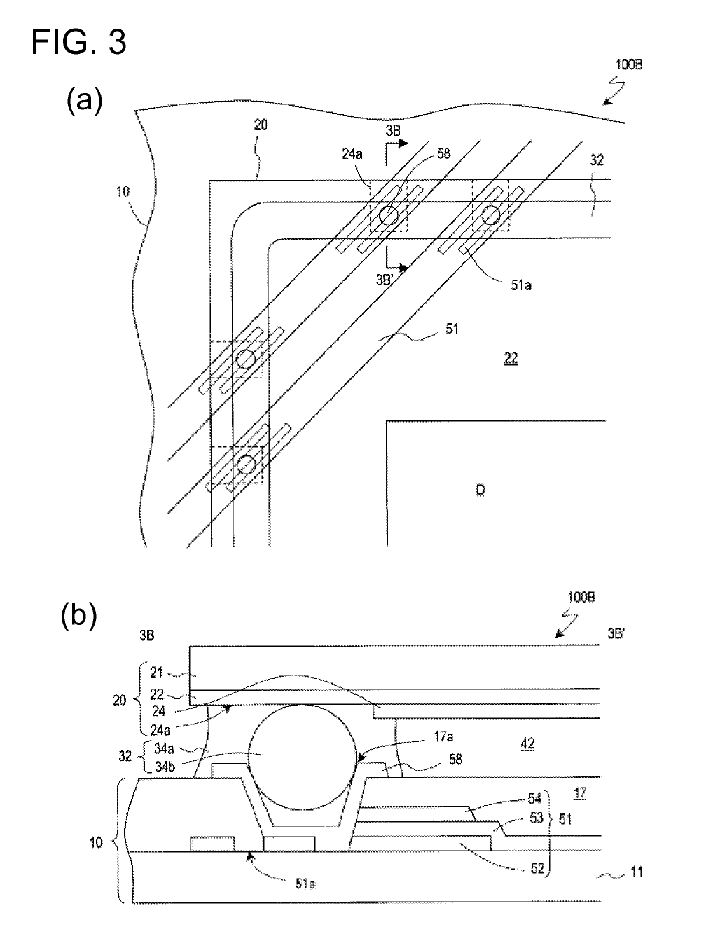

Next, the structure of the frame region of a liquid crystal display panel 100B, which is another embodiment of the present invention, will be described with reference to FIG. 3. FIG. 3(a) is a schematic plan view showing the frame region of the liquid crystal display panel 100B, and FIG. 3(b) is a schematic cross-sectional view taken along the line 3B-3B′ of FIG. 3(a).

The liquid crystal display panel 100B differs from the liquid crystal display panel 100A in that the wiring 51 has openings (slits) 51a in a portion that overlaps the sealant portion 32. The openings 51a, thus formed in the portion where the wiring 51 and the sealant portion 32 overlap, allows the sealant constituting the sealant portion 32 to be irradiated with the curing light more efficiently. Here, since the formation of the openings 51a increases the resistance of the wiring 51, the openings 51a should preferably be formed selectively only in the portion that overlaps the sealant portion 32.

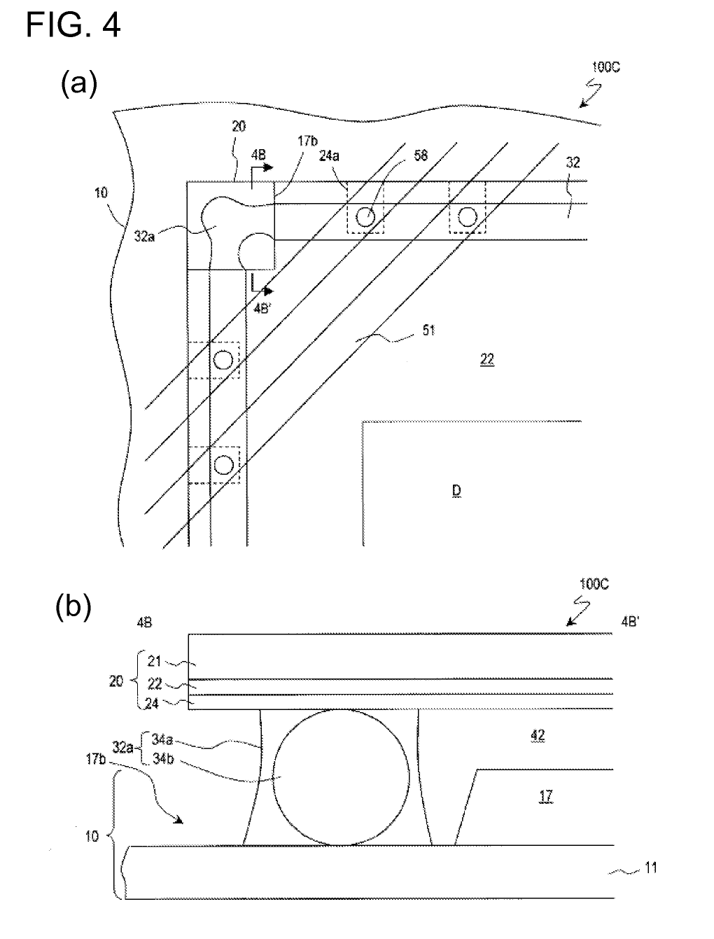

Next, the structure of a frame region of a liquid crystal display panel 100C, which is yet another embodiment of the present invention, will be described with reference to FIG. 4. FIG. 4(a) is a schematic plan view of the frame region of the liquid crystal display panel 100C, and FIG. 4(b) is a schematic cross-sectional view taken along the line 4B-4B′ of FIG. 4(a).

The liquid crystal display panel 100C differs from the liquid crystal display panel 100A in that the TFT substrate 10 includes a recess 17b in which the organic insulating film 17 is not present at the corner portions 32a of the sealant portion 32 pattern.

As the liquid crystal display panels have become larger in recent years, the conventional vacuum injection method is being replaced by the one drop filling method. With the one drop filling method, a pattern is formed of a sealant on either the TFT substrate or the opposite substrate to surround the region in which the liquid crystal layer is to be formed. The sealant pattern is formed by drawing the pattern using a dispenser, for example. The sealant pattern tends to become wider at corner portions of the sealant pattern since the movement of the nozzle of the dispenser, for example, slows down there.

For this reason, the liquid crystal display panel 100C shown in FIG. 4 includes a recess 17b that is disposed in regions of the TFT substrate 10 where the corner portions 32a of the sealant portion 32 will be formed, to provide locally widened gaps between the TFT substrate 10 and the opposite substrate 20. Since part of the sealant is absorbed into the recess 17b, the sealant is prevented from spreading over the substrate surface. Here, the recess 17b is formed by partially removing the organic insulating film 17, but a dent may alternatively be formed in the organic insulating film 17.

Furthermore, if any wiring is to be exposed in the recess 17b, notches (or openings) can be formed in a portion of the opposite electrode 24 that faces the recess 17b, in order to prevent the conductive beads 34b from making an electrical connection between the aforementioned wiring and the opposite electrode 24.

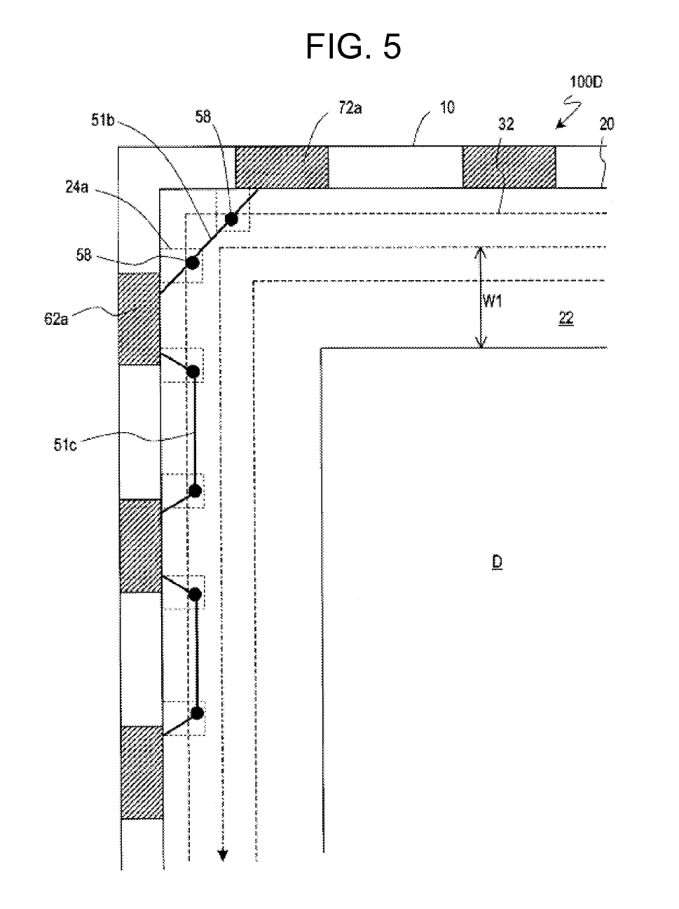

Next, the structure of a frame region of a liquid crystal display panel 100D, which is yet another embodiment of the present invention, will be described with reference to FIG. 5.

Similar to the liquid crystal display panels 100A through 100C, the liquid crystal display panel 100D includes two contact sections 58, which are formed where the gate driver wiring 51b overlaps the sealant portion 32 that is parallel to the horizontal direction and where the wiring 51b overlaps the sealant portion 32 that is parallel to the vertical direction. Additionally, the liquid crystal display panel 100D includes the contact sections 58 where a wiring 51c that connects adjacent gate driver terminals 62a overlaps the sealant portion 32. Notches (or openings) 24a are disposed in regions of the opposite electrode 24 that face the contact sections 58. Of course, a similar structure can also be employed for a wiring (not shown) for connecting adjacent source driver terminals 72a. Here, the gate driver terminals 62a and the source driver terminals 72a in FIG. 5 are simplified representation of a plurality of terminals to which the gate driver 62 and the source driver 72 (see FIG. 2, for example) are connected, respectively, through TCP or COF.

Furthermore, the black matrix 22 in the liquid crystal display panel 100D does not cover the entire sealant portion 32. The black matrix 22 only extends to approximately the midpoint of the width of the sealant portion 32, and does not overlap the half of the sealant portion 32 in which the portions overlapping the contact sections 58 are included. Therefore, as for the part of the sealant portion 32 that does not overlap the black matrix 22, the photocurable resin, which constitute the sealant portion 32, can be adequately cured by additionally irradiating with light from the side of the opposite substrate 20.

Of course, the structure shown in FIG. 5 may be applied to any of the liquid crystal display panels 100A, 100B, or 100C.

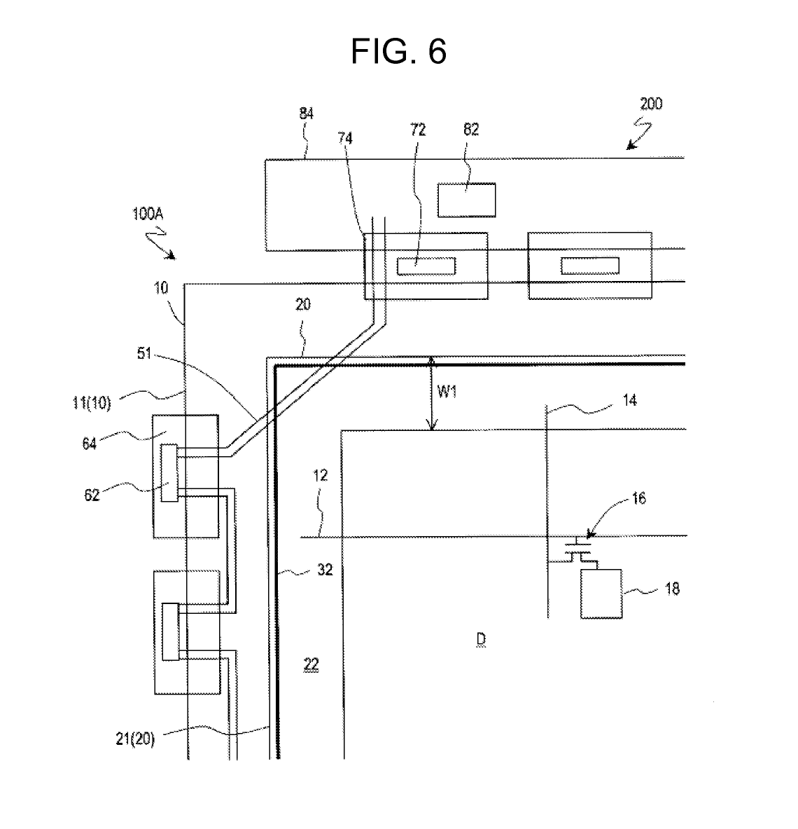

FIG. 6 is referenced next. In a liquid crystal display module in FIG. 6, the gate driver 62 and the source driver 72 are mounted on the liquid crystal display panel 100A. In the liquid crystal display module 100, the source drivers 62 are mounted on the TFT substrate 10 through COG. The liquid crystal display module 200, however, differs from the in liquid crystal display module 100 in that the gate drivers 62 are mounted on the TFT substrate 10 through COF (or TCP). Therefore, the liquid crystal display panel 100A according to embodiments of the present invention may be used regardless of how each driver is mounted.

Although liquid crystal display modules 100 and 200 include the liquid crystal display panel 100A as an example, the liquid crystal display panel 100B, 100C, or 100D, or a liquid crystal display panel having any combined features of 100B, 100C, and 100D may also be used in place of 100A.

The photocurable resin 34a used in the sealant is typically a UV curable resin, but is not limited to this and may be a resin that can be cured by light of other wavelengths (e.g., visible light). Furthermore, the photocurable resin refers to a resin that is cured under irradiation with light of predetermined wavelength, and includes resins that can be thermally cured after being optically cured. A combination with thermal curing generally enhances post-curing material properties (hardness and coefficient of elasticity). Furthermore, the sealant may contain particles for enhancing the scattering of lights (a filler) in addition to photocurable resin. A sealant in which such particles are dispersed promotes the scattering and diffuse reflection of light, which allows the light to spread across a wider area within the sealant. The conductive beads 34b may be gold-plated plastic beads.

### INDUSTRIAL APPLICABILITY

The present invention is preferably used for liquid crystal display panels, and particularly for TFT type liquid crystal display panels and liquid crystal display modules.

### DESCRIPTION OF REFERENCE CHARACTERS

10 TFT substrate
11, 21 glass substrate (transparent substrate)
12 gate bus line
14 source bus line
16 TFT
17 organic insulating film
17a contact hole
17b recess
20 opposite substrate
22 black matrix
24 opposite electrode
24a notch (or opening) in the opposite electrode
32 sealant portion
32a corner portion of the sealing pattern
34a photocurable resin
34b conductive beads
42 liquid crystal layer
51, 51b, 51c wiring (gate driver wiring)
51a opening (slit)
52, 54 conductive layer
53 insulating layer (gate insulating layer)
58 contact section (contact layer)
62 gate driver
62a gate driver terminal
72 source driver
72a source driver terminal
100A, 100B, 100C, 100D liquid crystal display panel
100, 200 liquid crystal display module

1. A liquid crystal display panel comprising:
a first substrate including a first transparent substrate, a plurality of pixel electrodes, a plurality of TFTs, a plurality of gate bus lines, a plurality of source bus lines, and an organic insulating film covering said plurality of gate bus lines and said plurality of source bus lines, wherein said plurality of pixel electrodes, said plurality of TFTs, said plurality of gate bus lines, said plurality of source bus lines, and said organic insulating film are formed on said first transparent substrate;
a second substrate including a second transparent substrate, wherein said black matrix and said opposite electrode are formed on said second transparent substrate;
a liquid crystal layer interposed between said first substrate and said second substrate; and
a sealant portion surrounding said liquid crystal layer, said sealant portion being made of a sealant containing a photocurable resin and conductive beads,
wherein the liquid crystal display panel has a display region and a non-display region surrounding said display region,
wherein said first substrate includes a wiring that crosses a first side and a second side of said second substrate, said first and second sides being adjoining each other, and said wiring includes two conductive layers which are layered with an insulating layer sandwiched therebetween,
wherein said first substrate includes a first contact section formed where said wiring crosses a first sealant segment of said sealant portion that is in parallel with said first side and a second contact section formed where said wiring crosses a second sealant segment of said sealant portion that is in parallel with said second side;
wherein said first contact section and said second contact section each have a contact hole formed in said organic insulating film and in said insulating layer, and a contact layer that is in contact with said two conductive layers inside said contact hole,
wherein said black matrix and said opposite electrode of said second substrate overlap at least a part of said sealant portion, and
wherein said opposite electrode is not formed in regions of said second substrate that face said first contact section and said second contact section.

2. The liquid crystal display panel according to claim 1, wherein said respective two conductive layers are formed of a same conductive layer as that of said plurality of gate bus lines and of the same conductive layer as that of said plurality of source bus lines, respectively.

3. The liquid crystal display panel according to claim 1, wherein said wiring has openings where said wiring overlaps said first and second sealant segments.

4. The liquid crystal display panel according to claim 1, wherein said contact layer is formed of a same conductive layer as that of said plurality of pixel electrodes.

5. The liquid crystal display panel according to claim 1, wherein said black matrix overlaps an entirety of said sealant portion.

6. The liquid crystal display device according to claim 1, wherein said first substrate has a recess in which said organic insulating film is not present in a corner portion of a pattern of said sealant portion.

7. The liquid crystal display panel according to claim 1, wherein an end of said wiring is connected to a gate driver disposed on said first substrate.
